(19) United States
(12) Patent Application Publication
(10) Pub. No.: US 2012/0284595 A1
(43) Pub. Date: Nov. 8, 2012

(54) Automatic Page Layout System and Method

(76) Inventors: Nicholas P. Lyons, Sunnyvale, CA (US); Stephen Philip Cheatle, Bristol (GB); Jun Xiao, Austin, TX (US); Clayton Atkins, Lexington, KY (US)

(21) Appl. No.: 13/509,109

(22) PCT Filed: Nov. 25, 2009
(86) PCT No.: PCT/US2009/065986

§ 371 Date: May 10, 2012

(51) Int. Cl. G06F 17/00

(52) U.S. Cl. 715/202; 715/243

(57) ABSTRACT

A method for modifying content items arranged on a display page. The method is carried out by a computer having a processor and a system memory and includes arranging the content items in content locations on the display page. An appearance of a content item is changed, and the change of appearance is associated with one of the content location and the content item. The change is retained in the system memory for subsequent reuse.

### BACKGROUND

Computer-generated photo albums are available that can automatically select and layout personal and licensed electronic media using rules based on accepted photobook or scrap booking practices. These generative photobook systems can greatly aid a user by creating a photo album in minutes rather than hours using manual techniques, and are especially helpful when the user's media collection contains hundreds or even thousands of objects.

However, the rule sets used for selecting and laying out a photo album may not conform to a user's desires or intents in achieving a desired aesthetic result. For example, design rules that produce an orderly rectangular layout of the media items on a page may not meet the desires of a user who wants to express their layout in a disordered design with overlapping images, media items oriented at random angles, half off the visible page, and the like. Nor will such rules accommodate a more typical user that just wants to stretch the allowed layout area on the page so that the image is a little bigger or overlaps the page's background template design.

When a system's rules are in conflict with the user's intents, allowing the user to break the rules can increase user satisfaction. However, deciding which rules to break, when to allow the user to break a rule, and determining a priority of which rule to relax is difficult to accomplish. Moreover, allowing a user complete freedom in disregarding the rules can quickly turn a good selection and layout for a photo album into an aesthetically displeasing work.

### BRIEF DESCRIPTION OF THE DRAWINGS

Various features and advantages of the present disclosure will be apparent from the detailed description which follows, taken in conjunction with the accompanying drawings, which together illustrate, by way of example, features of the present disclosure, and wherein:

FIG. 1 is a schematic view of an embodiment of a system for modifying content items on a display page in accordance with the present disclosure;

FIG. 2 is a view of an embodiment of an automatically generated display page layout in accordance with the present disclosure;

FIG. 3 is a view of an embodiment of the display page layout of FIG. 2 with a modified appearance in accordance with the present disclosure;

FIG. 4 is a view of an embodiment of the modified page layout template of FIG. 3 with the modification associated with a content item in accordance with the present disclosure;

FIG. 5 is a view of an embodiment of the modified display page layout of FIG. 3 with the modification associated with a content location of the page layout in accordance with the present disclosure;

FIG. 6 is a screen shot view of the display page layout of FIG. 2 being modified with a user interface in accordance with the present disclosure;

FIG. 7 is a view of an embodiment of the modified page layout of FIG. 3 with the modification being associated with a partition layer of the page layout in accordance with the present disclosure;

FIG. 8 is a view of another embodiment of a modified page layout with multiple modifications, each modification being associated with a different partition layer of the page layout in accordance with the present disclosure;

FIG. 9 is a diagram of an embodiment of a program matrix of a program used by a processor of a computer to associate changes with a content item or a content location in accordance with the present disclosure;

FIG. 10 is a schematic view of another embodiment of a system for modifying content items on a display page in accordance with the present disclosure;

FIG. 11 is a flow chart of an embodiment of a method for modifying content items of a display page in accordance with the present disclosure; and

FIG. 12 is a flow chart of another embodiment of a method for modifying content items of a display page in accordance with the present disclosure.

### DETAILED DESCRIPTION

Reference will now be made to exemplary embodiments illustrated in the drawings, and specific language will be used herein to describe the same. It will nevertheless be understood that no limitation of the scope of the present disclosure is thereby intended. Alterations and further modifications of the features illustrated herein, and additional applications of the principles illustrated herein, which would occur to one skilled in the relevant art and having possession of this disclosure, are to be considered within the scope of this disclosure.

As used herein, directional terms, such as “top,” “bottom,” “front,” “back,” “leading,” “trailing,” etc, are used with reference to the orientation of the figures being described. Because components of various embodiments disclosed herein can be positioned in a number of different orientations, the directional terminology is used for illustrative purposes only, and is not intended to be limiting.

As used herein, the term “computer” refers to any type of computing device, including a personal computer, mainframe computer, portable computer, PDA, smart phone, or workstation computer that includes a processing unit, a system memory, and a system bus that couples the processing unit to the various components of the computer. The processing unit can include one or more processors, each of which may be in the form of any one of various commercially available processors. Generally, each processor receives instructions and data from a read-only memory (ROM) and/or a random access memory (RAM). The system memory typically includes ROM that stores a basic input/output system (BIOS) that contains start-up routines for the computer, and RAM for storing computer program instructions and data.

A computer typically also includes input devices for user interaction (e.g., entering commands or data, receiving or viewing results), such as a keyboard, a pointing device (e.g. a computer mouse), microphone, camera, or any other means of input known to be used with a computing device. The computer can also include output devices such as a monitor or display, projector, printer, audio speakers, or any other device known to be controllable by a computing device. In some embodiments, the computer can also include one or more graphics cards, each of which is capable of driving one or more display outputs that are synchronized to an internal or external clock source.

The term “computer program” is used herein to refer to machine-readable instructions, stored on tangible computer-readable storage media, for causing a computing device including a processor and system memory to perform a series of process steps that transform data and/or produce tangible results, such as a display indication or printed indicia.

The terms “system memory”, “computer-readable media”, and “computer-readable storage media” as used herein includes any kind of memory or memory device, whether volatile or non-volatile, such as floppy disks, hard disks, CD-ROMs, flash memory, read-only memory, and random access memory, that is suitable to provide non-volatile or persistent storage for data, data structures and machine-executable instructions. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and optical disks, such as CD, CDROM, DVD-ROM, DVD-RAM, and DVD-RW. Any of the above types of computer-readable media or related devices can be associated with or included as part of a computer, and connected to the system bus by respective interfaces. Other computer-readable storage devices (e.g., magnetic tape drives, flash memory devices, and digital video disks) also may be used with the computer.

As used herein, the term “generative system” means an autonomous computer system that uses a few basic rules to yield extremely varied and unpredictable patterns. Generative systems can be systems that generate, compose, or construct an output, such as music, art, or a page layout for a photobook, in an algorithmic manner through the use of systems defined by computer software algorithms, or similar mathematical or mechanical or randomized autonomous processes. By definition a generative system uses a system, such as a software algorithm, as a production method. Such generative systems are self-contained and operate with some degree of autonomy. The workings of generative systems might resemble, or rely on, various scientific theories such as Complexity science and Information theory. Such systems may exhibit order and/or disorder, as well as a varying degree of complexity, making behavioral prediction difficult. However, such systems still contain a defined relationship between cause and effect. The term generative system has a well-established meaning in the discipline of autonomous computer programming, and those of skill in the art will be familiar with it. One well known example of a generative system is the online computer game Spore, in which users control the development of a species from its beginnings as a microscopic organism, through development as an intelligent and social creature, to interstellar exploration as a spacefaring culture.

The exemplary embodiments described herein generally provide for a system and method for allowing user modifications to an automatically generated layout of content items in content locations on a display page, such as an automatically generated photo album. A generative system can be used to define content locations on the display page based on characteristics of the content items in a collection and to place the content items in the content locations. User preferences can also be applied to the content items or content locations either by inference through analyzing user behavior, or directly through user input into a user interface. The user interface can be used to allow a user to change an appearance characteristic of a content item. The user can selectively assign the change to one of the content item and the content location. The changes can be associated with either the content item or the content location so that the next time the content item or the content location is used, the user preferences govern the appearance of the display page.

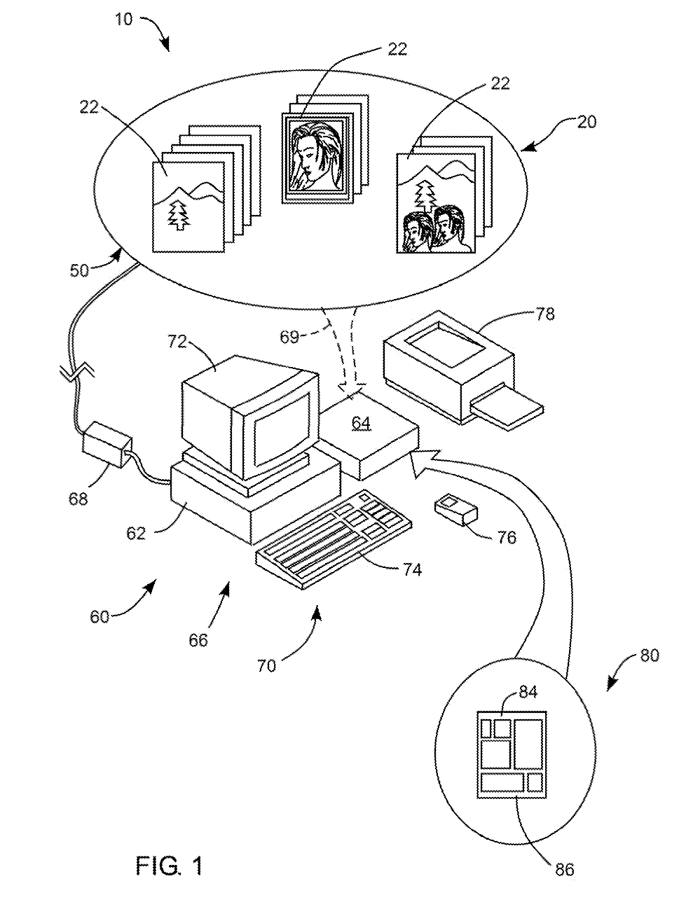

Provided in FIG. 1 is a schematic of view of one embodiment of a system for modifying content items arranged on a display page, indicated generally at 10. The system can include a collection of content items, indicated generally at 20, a computer, indicated generally at 60, a processor with software programming 62, and a system memory 64 accessible by the computer.

The collection of content items 20 can include media objects or content items 22 of any type of information digitally storable in computer readable storage memory, such as photographs, pictures, artwork, slides, video, and the like, that have been digitized or recorded on an electronic digital medium. The content items can also include electronic documents including text, graphs, graphics, tables, and the like. Other visual media, such as Computer-generated animation, annotations, decorative adornments, and the like, can also be included with the collection of content items or added after the collection has been uploaded.

In the embodiment shown in FIG. 1, the collection of content items 20 can be stored on an internet server, indicated generally at 50, accessible by a user through an internet enabled computer 60, such as a computer having an internet communication device 68, such as a modem or router. In another embodiment, as indicated by the dashed arrow at 69, the collection of content items 20 can be uploaded directly to a user's computer 60 and input into the computer system memory 64 of the computer for later use by the user.

The computer 60 can include the processor 62 and the system memory 64. The processor 62 can include means, such as software programming, for receiving the collection of content items 20 and automatically generating a page layout, indicated generally at 80, of content locations 84 on display pages 86. The page layout can be automatically generated based on characteristics of the individual content items 22.

In the embodiment shown in FIG. 1, the software program for generating the layout of content locations can include a generative system (not shown). The generative system can determine an area and location for all content items visible on the display page 86. Hence, the generative system can generate the number, size, shape and position of the content locations 84 based on characteristics of the content items 22 in the collection 20. For example, the generative system can automatically adjust spatial characteristics of the content locations such that the content items can be automatically spatially arranged on the display page 86 according to aspect ratios of the content items in the collection.

The generative system can generate additional content location configurations such that any number of content items 22 can fit on the display page 86. For example, a user can set parameters in the generative system such that one content item, two content items, three content items, and so forth can fit on the display page. Additionally, during operation of the system, if a user desires that each display page have a certain number of content items 22, the generative system can adjust various spatial characteristics of the content locations 22 so as to generate a content location template having a maximum number of content items specified by the user.

The processor 62 can also include means, such as software programming, for changing an appearance of a content item 22. For example, the processor can include a software program that can allow a user to change an appearance characteristic of either the content item 22 or content location 84. The appearance characteristic can be a cosmetic change that preserves a layout design of the content locations, a design change that alters a layout design of the content locations, or a combination of cosmetic changes and design changes.

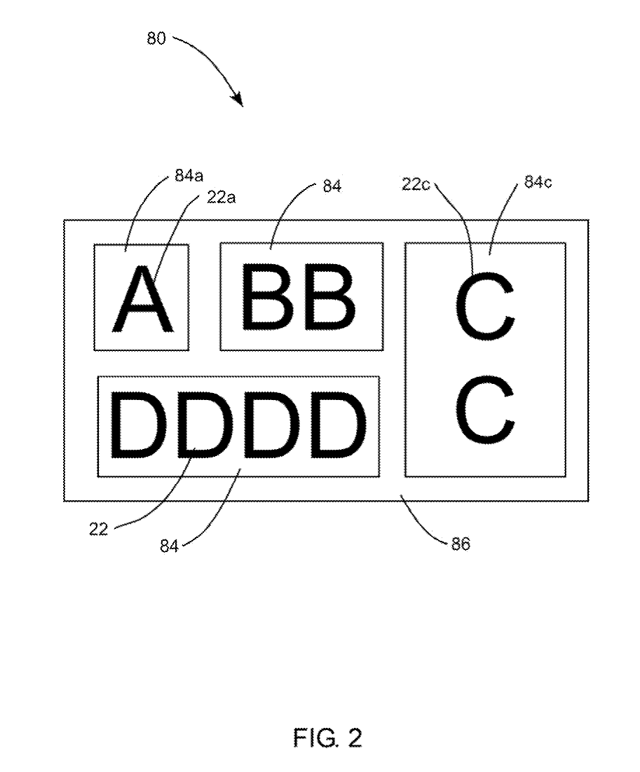

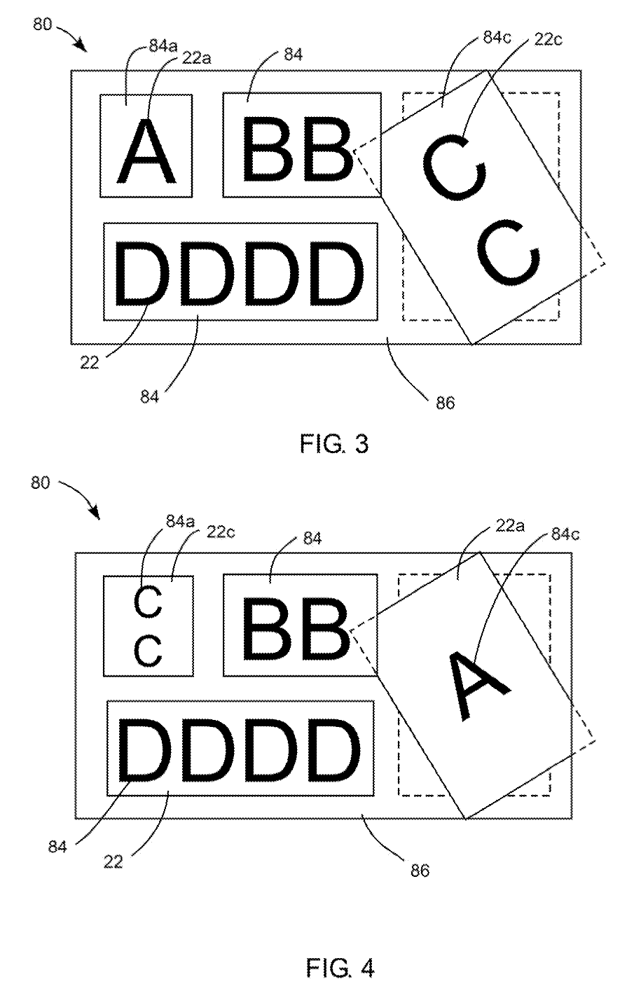

FIGS. 2-4 illustrate an exemplary change to a content location 84. Examples of the kind of changes that may be applied to a content location include: rotating of one of the defined content locations 84c, as seen in FIG. 3, moving the position of one of the content locations on the page, changing the size of one of the defined content locations, re-shaping of one of the defined content locations, overlapping of one of the defined content locations in relation to adjacent content locations, changing color properties of visual media placed in one of the defined content locations, and the like. Any change made to a content location 84 can be associated with the content location so that when the layout of content locations 80 is used again with different content items 22 placed in the modified content location, the content item in the changed content location will appear with the change associated with the content location.

Thus, as shown in FIG. 2, the content item 22c with the letter C has been assigned to a content location 84c. In FIG. 3, the content item 22c with the letter C appears rotated and the rotation has been associated and retained with the content location 84c. Consequently, as seen in FIG. 4, the content item 22a with the letter A has been moved to the content location 84c formerly occupied by the content item 22c with the letter C, and the content item 22a with the letter A now appears rotated. With the rotation modification associated and retained with the content location 84c, any content item 22 placed in the content location 84c will automatically be rotated.

It will be appreciated that while the change of appearance illustrated in FIGS. 2-4 is a rotation modification, any of the changes in appearance discussed above can be associated and retained with the content location 84 so that when the page layout 82 is reused with different content items, any content item 22 placed in the modified content locations will subsequently be similarly modified.

FIGS. 2, 3, and 5 illustrate an exemplary change in appearance of a content item 22. Examples of the kind of changes that may be associated with the content item include: changing the size, shape, angular rotation and orientation, color hue, sharpness, cropped size, brightness, contrast, threshold, and color properties of the content item. Other visual characteristics, as known in the art can also be modified. In this way, the modifications can be associated to the content item 22 so that whenever the content item is reused in a content location of a generated or selected page layout, the content item will always appear with the changed or modified appearance.

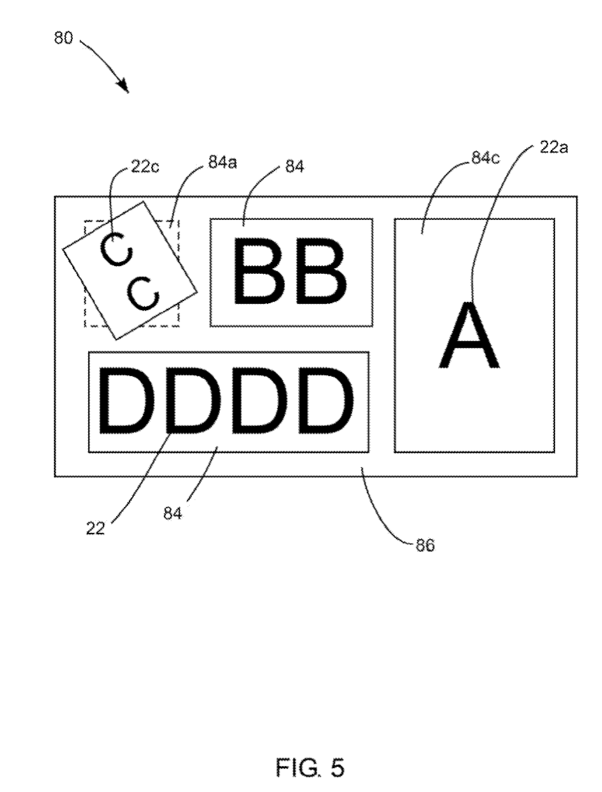

Thus, as shown in FIG. 2, the content item 22c with the letter C has been assigned to a content location 84c. In FIG. 3, the content item 22c with the letter C appears rotated and, in this case, the rotation has been associated with the content item 22c. Consequently, as seen in FIG. 5, the content item 22c has been moved to the content location 22a formerly occupied by the content item 84a with the letter A, and the content item 22c now in the content location 84a appears rotated. Additionally, the content item 22a is now located in content location 84c and is not rotated. Hence, with the rotation modification associated with the content item 22c, any use of the content item 22c will automatically be similarly rotated regardless of which content location the content item is placed on the page layout.

It will be appreciated that while the modification illustrated in FIGS. 2, 3, and 5, is a rotation modification of the content item 20, any of the modifications discussed above can be associated and retained with the content item 22 so that when the content item is reused in a different page layout 84, the content item 22 will subsequently be similarly changed in appearance.

As noted above, some types of changes of appearance can be cosmetic changes and others can be design changes. Cosmetic changes do not alter the placement of the content item 22 in the layout of content locations 80, and do not re-run the generative system in order to modify the layout of content locations to accommodate the change. For example, if the content item is rotated, the layout of the content locations does not need to be regenerated to accommodate the rotation and the change is a cosmetic change. Cosmetic changes can be stored in the system memory 64 for subsequent reuse.

However, design changes do re-run the generative system in order to generate a new layout of content locations so as to accommodate the change. Thus, for example, if a content item 22 is deleted from a layout of content locations 80, then the generative system can be re-run in order generate a new layout of content locations without the content location 84 containing the content item that was deleted. Design changes are routed to the generative system to generate a new layout, and the newly generated layout of content items can be stored in the system memory 64.

Cosmetic and design changes can be the types of appearance changes discussed above. Additional exemplary type of changes of appearance that can be cosmetic and design changes can include changes to size, shape, rotation, color hue, sharpness, cropped size, brightness, contrast, threshold, color properties, spatial distortion, and one to one image spatial remapping. Moreover, changes to artistic texture rendering that makes a content item appear as if created in a different media such as pencil, charcoal, oil paint, water color, brush strokes, stained glass effects, adding texturing, and the like can also be either cosmetic or design changes. Furthermore, changes such as Gaussian, motion, and radial blurring effects can be cosmetic or design type changes, as well as sharpening effects. Other changes such as noise effects, adding or removing image noise, and pixilation, including half-toning, reduction to mosaic tiles, converting to pointillist rendering, and edge enhancement, embossing effects, spatial filtering, high pass, low pass or band pass spatial features, and water marking can also be cosmetic or design changes. It will be appreciated the foregoing list is only exemplary and not exhaustive. Other types of visual appearance changes can also be used as cosmetic or design changes.

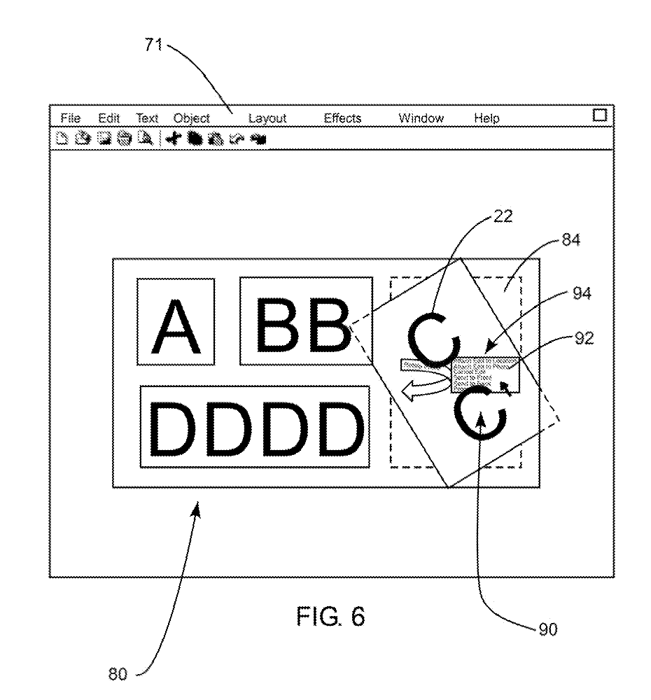

Referring to FIGS. 1 and 6, the processor 62 can also include means, such as software programming, for associating the change of appearance with one of one of the content location 84 and the content item 22. For example, the program on the processor can include a user interface, indicated generally at 90 (FIG. 6), to allow a user to assign the change of appearance to one of the content location and the content item.

The user interface can include a keyboard 74, a pointing device such as a computer mouse 76, and a monitor 72. The user interface can also include programming within the processor 62 that can provide interactive menus, such as a pop up menu 92 as seen in the representation of a screen 71 in FIG. 6 that can be displayed on the monitor. Options on the pop up menu can be selected by a user with either the mouse or the keyboard. The interactive menus, such as the pop up menu 92, can provide a plurality of change of appearance options, indicated generally at 94. The change of appearance options can allow a user to change the appearance of the content items 22. The modification or change options can change the visual appearance of the content items by modifying the content locations 84 of the page 80 and by modifying the visual characteristics of the content items 20.

The system 10 can also include a system memory 64 configured to retain the change of appearance for subsequent reuse. The processor 62 can provide a means for retaining the changes to the appearance of the visual media 22 on the page layout 80 in the system memory 64 for subsequent reuse. For example, the processor can include programming that can be activated to record the modifications to the appearance of the content item 22 on the page layout template 84 and store the modifications in the system memory. In this way, as discussed above, when the content item 22 or page layout 84 is used again, the saved modifications can be used to recreate the changes to the appearance of the visual media on the page layout template.

The means for retaining the changes can include retaining changes of appearance with the content item 22, such as by programming, which can record and store the change of appearance in the system memory 64. In this way, the content item 22 can be associated with the modification such that subsequent use or reuse of the content item can result in the same changed visual appearance whenever the content item is used on a generated or selected page layout 80.

The means for retaining the changes can also include retaining changes with the content location 84, such as by programming, which can record and store the change in the system memory 64. In this way, the content location 84 can be associated with the modification such that subsequent use or reuse of the content location can result in similar changes to the appearance of any content item 22 that is displayed in the content location 84 on the page layout.

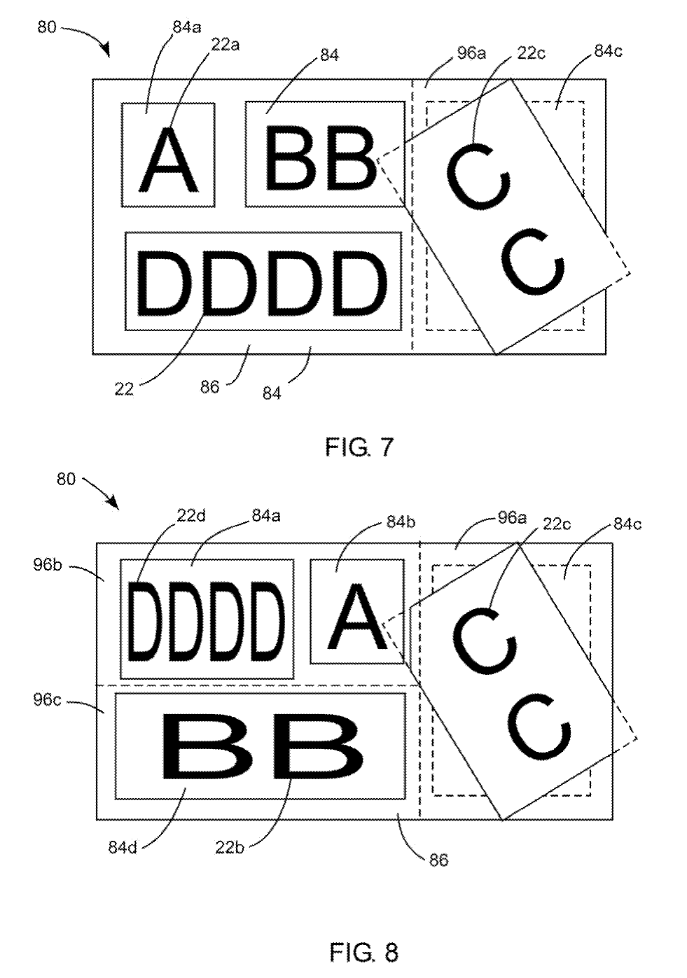

Provided in FIGS. 7-8 is another embodiment of the means for retaining changes to the page layout 86. In this case, the means for retaining the changes to the page layout can include programming on the processor 62 that can create at least one partition layer 96a associated with the page layout 86.

As seen in FIG. 7, the changes, shown as a rotation of the content item 22c with the letter C, can be created as a partition layer 96a on the page layout 86. The page layout template with the partition layer can then be recorded and stored in the system memory 64 for subsequent reuse to recreate the visual appearance of the modifications made in the partition layer.

Additionally, as seen in FIG. 8, each change to the page layout template 84 and the content items 22 can be stored on different partition layers 96a, 96b, and 96c so that additional changes can be made to other areas of the page layout 86 or adjacent visual media without affecting the adjacent partition layers.

Returning to FIG. 1, in addition to the processor 62, the system 10 can also include an output device for outputting the display page 80. The output device can be any electronic device which allows viewing of the display page 86 by a user, such as a monitor 72, a screen of a personal digital assistant (PDA), and the like. The output device can also be an electronic device capable of outputting a hard copy of the display page such as a printer 78, plotter, and the like. The display page can be stored in an electronic storage medium such as a database accessible by the internet, a hard disk, flash memory, and the like. The electronic storage medium can be accessible by the output device.

In use, the generative system can determine an area and location for all content items 22 visible on the display page 86. The generative system can produce a candidate layout of content locations 80 that can be passed on to the processor 62 and can transform and store the candidate layout. Additionally, the processor can maintain a record of cosmetic changes that do not affect the content locations on a page layout and apply modifications to the candidate layout resulting in a realized layout that can be presented to the user. After review the user may make more modifications that can ripple back for further processing either by re-running the generative system or using the processor and system memory to associate the modifications with the content item.

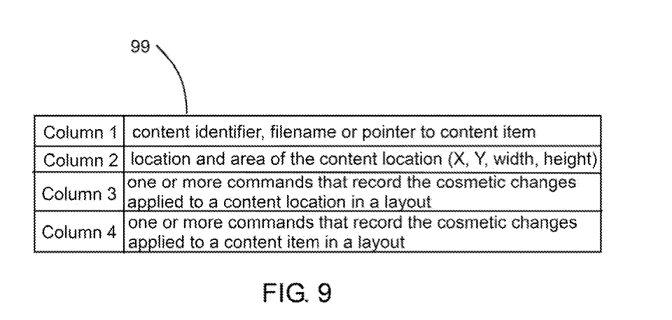

The processor program that can apply and store user defined changes of appearance can include a storage matrix or table 99 having at least four columns, as seen in FIG. 9. Column 1 can include a content identifier, filename, or pointer to a content item. Column 2 can include information on a content location such as X, Y positioning and width and height of the content location. Column 3 can include one or more commands that record the cosmetic changes applied to a content location in a layout. Column 4 can include one or more commands that record the cosmetic changes applied to a content item in a layout.

A row in the table may have either column 3 or column 4 or both filled in. For example, if a row had column 3 set to “rotate 3 degrees” and column 4 set to “create drop shadow” then the content item would have both a drop shadow due to the column 4 setting and be rotated slightly by 3 degrees due to the positional modification of column 3. If later user activity causes the content item to no longer appear in the same position as before, then column 4 modifications follow the content item 22 whereas column 3 modifications stick to the content location 84.

Any time the generative system re-runs to create a candidate layout column 2 is rewritten. Column 1 may be updated partially or completely. The table takes the candidate layout from the generative system and applies the command modification from column 3 and column 4 to content locations 84 or to content items 22 in the layout, respectively, to create the realized layout. The user then views the realized layout and can interact with the program's user interface to make modifications to the layout of content locations 80.

In this way, the programming of the processor 62 can associate the change of appearance to either or both of the content item 22 and the content location 84.

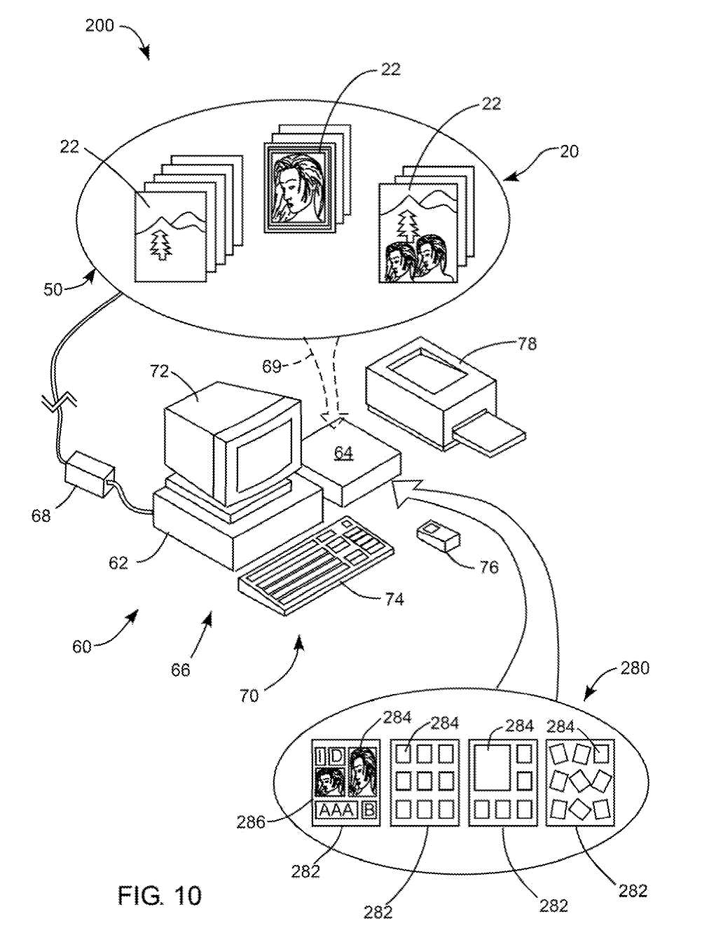

Provided in FIG. 10 is a schematic of view of another embodiment of a system for modifying content items arranged on a display page, indicated generally at 200. The system 200 can be similar in many respects to the system 10 described above and shown in FIG. 1. The system 200 can include a collection of content items, indicated generally at 20, a computer, indicated generally at 60, a processor with software programming 62, and a system memory 64 accessible by the computer.

Additionally, the processor 62 can access a plurality of page layout templates 282 stored in the system memory 64 or on an internet server as a library of predefined page layout templates, indicated generally at 280. The processor can place, automatically organize, and output content items 22 from the collection of visual media 20 into defined content locations 284 in the page layout templates 282. Additionally, the user can manually place content items into the content locations via the user interface. When the content items are organized into the page layout templates, the page layout templates can then be output to a display, such as a video monitor 72, or to a printer 78 in order to produce the display pages 286.

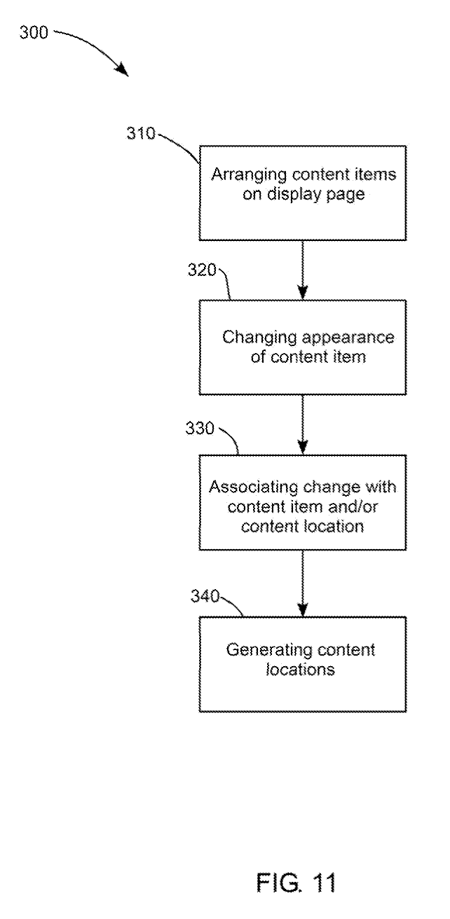

Provided in FIG. 11 is a flow chart outlining the steps in one embodiment of a method for modifying content items arranged on a display page. The method can be carried out by a computer having a processor and a system memory. The method, indicated generally at 300, includes arranging the content items in content locations on the display page, as indicated at 310. The appearance of the content item can be changed, as indicated at 320. The change of appearance can be associated with one of the content location and the content item, and retaining said change in the system memory for subsequent reuse, as indicated at 330.

The method can also include generating the content locations with a generative system that generates the number, size, shape and position of the content locations based on characteristics of the content items in a collection, as shown at 340.

Additionally, in one aspect, the change of appearance can be associated with the content location such that any content item occupying the content location is similarly changed in appearance. In another aspect the change of appearance can be associated with the content item such that the content item retains the changed appearance when used in any slot in any page layout template.

Moreover, the step of changing an appearance of a content item can include a cosmetic change of the content item that preserves a layout design of the content locations, a design change of the content item that alters a layout design of the content locations, or combinations of cosmetic and design changes.

The step of changing the appearance of the content item can also include creating at least one partition layer with at least one of the content locations with the changes to the appearance of the content item associated with the at least one content location of the at least one partition layer. The at least one partition layer can be recorded in the system memory. The at least one recorded partition layer can be reused in order to duplicate the changes on a subsequent use of the content location.

The method can also include selecting a predefined page layout template from a library of predefined templates where each template has a predefined number of content locations for receiving content items. The predefined page layout template can be selected automatically by a computer program executed on the computer processor, or manually by a user.

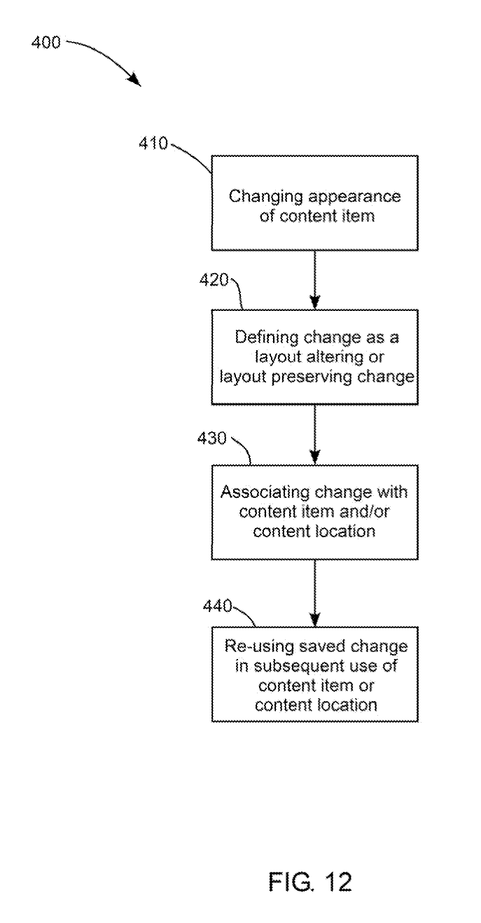

Provided in FIG. 12 is a flow chart outlining the steps in another embodiment of a method for modifying an arrangement of content items on a display page having a page layout. The method can be carried out by a computer having a processor and a system memory. The method, indicated generally at 400, can include changing an appearance of a content item on the page, as indicated at 410. The changed appearance can be defined as a layout-altering change, a layout-preserving change, or a combination of layout-altering and layout-preserving changes, as indicated at 420. The changed appearance can be associated with one of the page layout and the content item, as indicated at 430.

The method can also include generating content locations on the page layout with a generative system that generates the number, size, shape and position of the content locations based on characteristics of the content items in a collection. The content items can be arranged in the content locations on the display page.

Additionally, the method can include reusing the content item with the changed appearance to duplicate the changed appearance on a different page layout. Similarly, the method can include reusing the generated content locations with the changed appearance to duplicate the changed appearance on a different content item input into the content location on the page layout.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims.

What is claimed is:

1. A method for modifying content items arranged on a display page, the method being carried out by a computer having a processor and a system memory, comprising the steps of:
arranging the content items in content locations on the display page;
changing an appearance of a content item; and
associating the change of appearance with one of the content location and the content item, and retaining said change in the system memory for subsequent reuse.

2. A method in accordance with claim 1, further comprising the step of:
generating the content locations with a generative system that generates the number, size, shape and position of the content locations based on characteristics of the content items in a collection.

3. A method in accordance with claim 1, wherein the change of appearance is associated with the content location, such that any content item occupying the content location is similarly changed in appearance.

4. A method in accordance with claim 1, wherein the change of appearance is associated with the content item, such that the content item retains the changed appearance when used in any content location in any page layout template.

5. A method in accordance with claim 1, wherein the step of changing an appearance of a content item includes a cosmetic change of the content item that preserves a layout design of the content locations.

6. A method in accordance with claim 1, wherein the step of changing an appearance of a content item includes a design change of the content item that alters a layout design of the content locations.

7. A method in accordance with claim 1, further comprising the step of:
selecting a predefined page layout template from a library of predefined templates, each template having a predefined number of content locations for receiving content items; and
wherein the predefined page layout template is selected by a method selected from the group consisting of an automatic selection performed by a computer program executed on the computer processor, a manual selection performed by a user, and combinations thereof.

8. A method in accordance with claim 1, wherein the step of changing the appearance of the content item further comprises:
creating at least one partition layer with at least one of the content locations, the changes to the appearance of the content item being associated with the at least one content location of the at least one partition layer;
recording the at least one partition layer in the system memory; and
reusing the at least one recorded partition layer to duplicate the changes on a subsequent use of the content location.

9. A method in accordance with claim 1, wherein the content items are selected from the group consisting of digitized photographs, digital images, video, digital video, text, graphics, and combinations thereof.

10. A method for modifying an arrangement of content items on a display page having a page layout, the method being carried out by a computer having a processor and a system memory, comprising the steps of:
changing an appearance of a content item on the page;
defining the change as one of a layout-altering and a layout-preserving change; and
associating the change of appearance with one of the page layout and the content item.

11. A method in accordance with claim 10, further comprising the step of:
generating content locations on the page layout with a generative system that generates the number, size, shape and position of the content locations based on characteristics of the content items in a collection; and
arranging the content items in the content locations on the display page.

12. A method in accordance with claim 11, further comprising:
reusing the content item with the changed appearance to duplicate the changed appearance on a different page layout; and
reusing the generated content locations with the changed appearance to duplicate the changed appearance on a different content item input into the content location on the page layout.

13. A system for modifying content items arranged on a display page, comprising:
a computer having a processor and programming, stored in tangible computer-readable storage media, configured to generate a layout of content locations filled with content items on a display page;
means for changing an appearance of a content item;
means for associating the change of appearance with one of the content location and the content item; and
a system memory configured to retain said change for subsequent reuse.

14. A system in accordance with claim 13, wherein the means for changing an appearance of a content item includes a program, stored in tangible computer-readable storage media associated with the processor, configured to allow a user to change an appearance characteristic selected from the group consisting of a cosmetic change that preserves a layout design of the content locations, a design change that alters a layout design of the content locations, and combinations thereof.

15. A system in accordance with claim 13, wherein the means for associating the change of appearance with one of the content location and the content item includes a program, stored in tangible computer-readable storage media associated with the processor, having a user interface to allow a user to assign the change of appearance to one of the content location and the content item.
